(19) United States
(12) Patent Application Publication
(10) Pub. No.: US 2006/0000320 A1
(43) Pub. Date: Jan. 5, 2006

(54) Ratchet wrench tool assembly for underground work and process of using

(76) Inventors: William M. Hutton, Nazareth, PA (US); Frank P. Russo, Swiftwater, PA (US)

Correspondence Address: John F. McNulty;Paul & Paul, 2900 Two Thousand Market Street, Philadelphia, PA, 19103, US

(21) Appl. No.: 10/881,790

(22) Filed: Jun. 30, 2004

(51) Int. Cl. B25B 23/16

(52) U.S. Cl. 81/177.8

(57) ABSTRACT

A tool and a process of using the tool is provided, whereby nuts, bolts, etc. may be worked on in a hole below ground that is substantially deeper than the hole opening at ground level, wherein a ratchet wrench tool assembly is provided, with the ratchet being below ground and having a plurality of different sized wrench heads adapted to be used therewith, and actuable from above ground by moving an elongate handle backwardly and forwardly, to have a below-ground pawl engage different teeth of the ratchet.

### BACKGROUND OF THE INVENTION

In the art of working on underground pipes, it has been conventional for workers to dig a hole to access the pipe beneath ground, with the hole being of sufficient size that workers can get down into the hole, to work on the underground pipe. Frequently, the underground pipe is on the order of 4 feet below the ground surface, such that the hole must first be excavated, and such excavation must be sufficient in amount to allow one or more workers to enter the hole and have sufficient room to work on the underground pipe.

Depending upon the depth of the pipe beneath the ground surface, the usual process requires excavation of large amounts of earth, causing considerable disruption to the surrounding landscape.

The present invention is directed to providing a ratchet wrench tool assembly for working on various sized nuts, bolts and the like associated with underground pipes, wherein the pipes are at a sufficient distance below ground to accomplish their purpose, generally being below the frost line, and often at a depth of approximately 4 feet.

In accordance with the present invention, the tool assembly of this invention is adapted to operate through a relatively small hole at the ground surface, generally on the order of 18 inches, notwithstanding that the underground water, gas, main, or other pipe may be at a level below ground of up to 4 feet or more.

### SUMMARY OF INVENTION

The present invention is directed to a ratchet wrench tool assembly and a process of using it, for working on various sized nuts, bolts and the like associated with underground pipes, through a small hole at the ground surface, and wherein the ratchet mechanism associated with the tool assembly, while being at a location below ground proximate the location of the pipe to be worked on, such ratchet mechanism can be driven from above ground.

Also, in accordance with this invention, different sized wrench heads may be used, for accommodating different sized nuts, bolts or the like.

Accordingly, it is a primary object of this invention to provide a novel ratchet wrench tool assembly for working on pipes below ground, through a small hole at the surface of the ground.

It is another object of this invention to accomplish the above object, through a given elongate handle member that is actuable from above ground, and which may employ any of a desired number of selected wrench heads, depending upon the size of the nut or bolt or the like with which the ratchet wrench is to be used, below ground.

It is another object of this invention to accomplish the above objects, wherein the ratchet wrench tool assembly employs a spring-loaded ratchet pawl and a drive rod.

It is a further object of this invention to provide a plurality of processes, by which underground work on pipes may be accomplished through the use of a ratchet wrench tool assembly as described above.

Other objects and advantages of the present invention will be readily apparent upon a reading of the following brief descriptions of the drawing figures, the detailed descriptions of the preferred embodiments, and the appended claims.

### BRIEF DESCRIPTION OF THE DRAWING FIGURES

FIG. 1 is a vertical sectional view, taken through ground, showing a hole therein, wherein the access opening to the hole is considerably smaller in dimension than the depth of the hole, and wherein a ratchet wrench tool assembly is shown placed in the hole, the tool assembly being shown foreshortened, for the sake of clarity, due to the length of the tool handle.

FIG. 2 is a view similar to that of FIG. 1, somewhat enlarged, and showing a bolt at the end of a pipe, that is adapted to be worked on by the tool assembly of this invention.

FIG. 3 is an enlarged detail view, fragmentally illustrated, in elevation, of a spring loaded pawl, in engagement with a ratchet tooth.

FIG. 4 is a view of a wrench head of a larger size than that illustrated in FIG. 2, for use on a pipe end bolt of a larger size than that of FIG. 2.

FIG. 5 is an illustration similar to that of FIG. 4, showing an even larger wrench head, adapted to be mounted on the same head mount that carries the ratchet, and which is shown in FIG. 2.

### DETAILED DESCRIPTION OF THE PREFERRED EMBODIMENTS

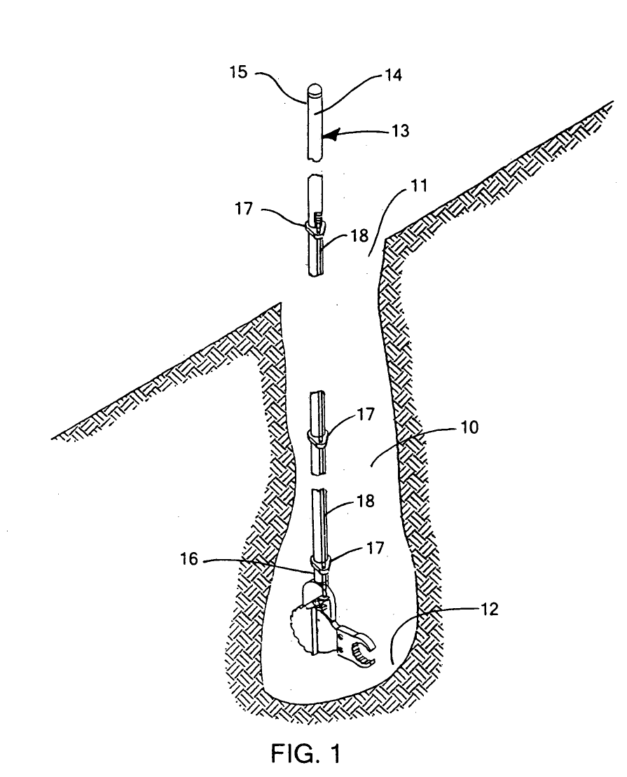

Referring now to the drawings in detail, reference is first made to FIG. 1, wherein a hole in the ground is generally designated by the numeral 10, having a relatively small access opening 11 at the upper end, and extending to the bottom of the hole 10 at 12.

A ratchet wrench tool assembly in accordance with this invention is generally designated by the numeral 13, and is shown in the hole 10. The tool assembly 13 includes an elongate handle member 14 extending from its upper end 15, to its lower end 16.

Placed along the handle member 14, at a plurality of locations, are a plurality of clamps 17, clampingly engaging the outer surface of the handle member 14, and which carry an elongate release rod 18.

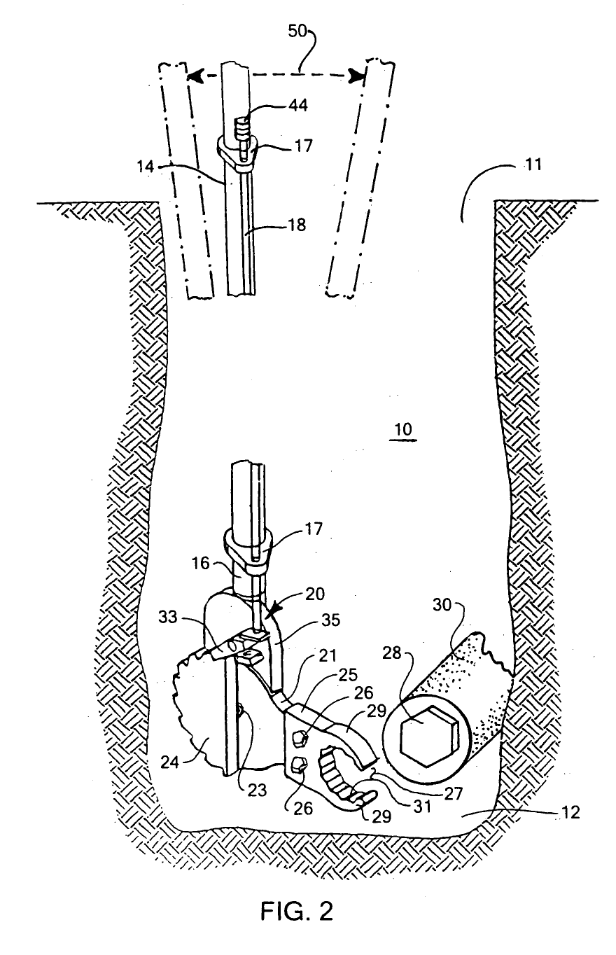

As can be seen more clearly in FIG. 2, a plate assembly 20 is carried at the lower end of the handle member 14, fixedly mounted thereto.

The plate assembly 20 has a pivotal ratchet mount plate 21, pivotally mounted thereto, via a rotatable shaft 23, and carries a toothed ratchet 24 mounted to the pivotal mount 21, for pivotal movement therewith, through an arc that ranges from 0° to 180°, relative to the fixed plate 35 carried by the lower end of handle member 14.

The ratchet mount plate 21, in turn, carries a wrench head 25, bolted thereto, by bolts 26, and is open ended as shown at 27 between spaced-apart jaws 29 to allow for clearance over a pipe, around a-bolt head 28, as shown, at the end of underground pipe 30, or the like. Teeth 31 on the wrench head 25 engage a bolt head, nut or the like 28, in a conventional manner.

The toothed ratchet 24 has a plurality of teeth 32, to be engaged by a pawl 33, pivotally carried via pivot shaft 34, that, in turn, is carried by the fixed plate 35.

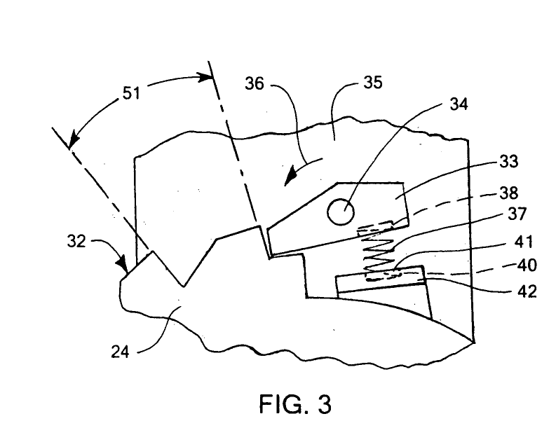

The pawl 33 is spring-urged toward a counter-clockwise direction as indicated by the arrow 36 in FIG. 3, by means of a compression spring or the like 37. It will understood that any other type of spring may be used. The compression spring 37 is preferably seated in respective recessed seats 38 and 40, respectively at the lower end of the pawl 33, to the right of the pivot 34 as shown in FIG. 3 and in a recess 41 disposed in a mounting plate tab 42, that, in turn, is carried by the fixed plate 35.

At the upper end of the release rod 18, there is a release button 44, as shown in FIG. 2.

Thus, it will be understood that the spring 37 normally urges the pawl 33 into engagement with a pawl tooth 32, and that, when it is desired to tighten or untighten a bolt, nut or the like 28, for example, the handle 14 may be engaged at the upper end and moved in a pivotal direction, back, and forth, as shown, between the two phantom positions therefore shown in FIG. 2, generally through an arc indicated as 50 in FIG. 2, that would generally be about 20°, to correspond with the degree differential between adjacent teeth 32 of the toothed ratchet 24, as shown in FIG. 3, which are also 20° apart as shown at 51.

Thus, the wrench assembly may be used to turn a bolt, nut or the like 20° at a time, and with the ratchet operating such that the pawl engages one tooth at a time, the turning motion for a nut, bolt or the like will be 20° for each ratchet tooth that is engaged by the pawl 33, for a maximum of 180°. Thereafter, the tool is removed and the ratchet assembly is re-positioned at the lower end 16 of the tool, for movement through another 180° arc, tooth by tooth in the same manner.

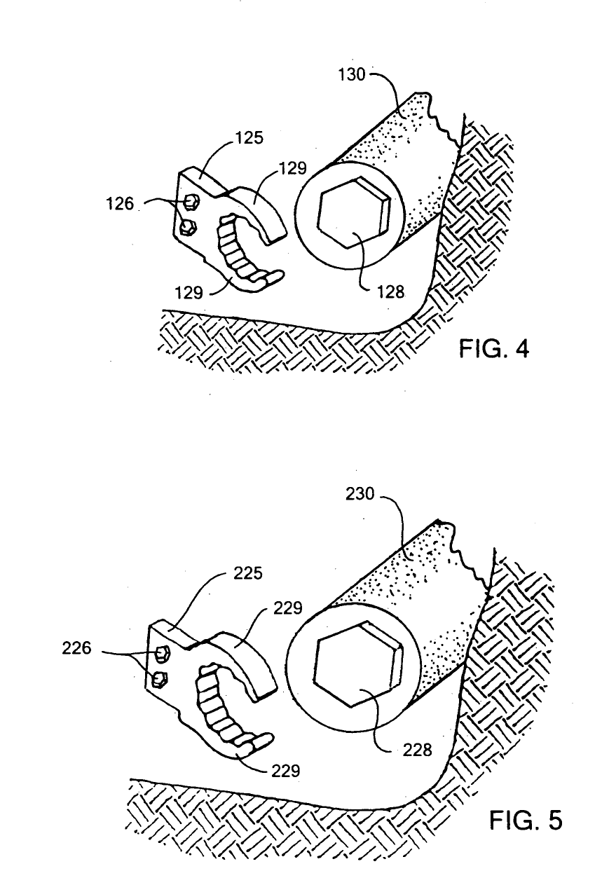

With reference to FIG. 4, it will be seen that the jaws 129 of the wrench head 125 are larger than those for the tool of FIG. 2, in order to accommodate a larger bolt, nut or the like 127, but that the mounting placement of the bolts 126 are the same as that shown in FIG. 2, so that the same pivotal mount 21 of FIG. 2 may be used to mount the wrench of FIG. 4 thereon.

Similarly, with reference to FIG. 5, it will be seen that even larger jaws 229 are used, with the same spacing between bolts 226, such that a single tool assembly may accommodate different heads 25, 125, 225, with the changes in heads being done by withdrawal of the handle upwardly, for placement of different heads on the lower end of the tool.

Thus, the operator or worker can readily reposition the ratchet to accommodate the tool to different situations, without substantial effort.

It will be apparent from the forgoing that various modifications may be made in the details of construction, as well as in the use and operation of the tool assembly of this invention, all within the spirit and scope of the invention as defined in the appended claims.

What is claimed is:

1. A ratchet wrench tool assembly for working on various sized nuts and bolts associated with underground pipes, through a hole at the ground surface and optionally employing any one of a plurality of pipe-engaging wrench heads for different sized nuts or bolts, wherein the depth of the pipe below ground is substantially greater than the size of the hole at the ground surface, the tool assembly comprising:
(a) an elongate handle member adapted to extend, at an upper end of the handle member from a position substantially above a ground level hole to a location substantially proximate a below ground pipe at a lower end of the handle member;
(b) a ratchet mechanism of the ratchet teeth and pawl type mounted at a lower end of the handle member;
(c) a ratchet pawl drive rod means adapted to extend from a position above a ground level hole to a ratchet pawl at the lower end of the handle member and comprising means for actuating said ratchet pawl from above ground;
(d) the ratchet teeth being carried by a toothed ratchet for turning movement therewith upon actuation by said drive rod means;
(e) with the toothed ratchet having a wrench head connectably and disconnectably mounted for movement with said toothed ratchet; whereby
(f) different sized wrench heads, each with multi-faceted nut or bolt gripping surfaces may be mounted for movement with said toothed ratchet to accommodate different sized nuts or bolts.

2. The ratchet wrench tool assembly of claim 1, wherein said wrench head is open-ended for clearance over a pipe with which it is to be used.

3. The ratchet wrench tool assembly of claim 1, wherein the wrench head is mounted for movement with the toothed ratchet by threaded connectors.

4. The ratchet wrench tool assembly of claim 1, wherein the drive rod means is carried by and disposed substantially parallel to said handle member.

5. The ratchet wrench tool assembly of claim 1, wherein a push button means is provided at the upper end of said drive rod means, for manually actuating said drive rod means.

6. The ratchet wrench tool assembly of claim 1, wherein said wrench head is open-ended for clearance over a pipe with which it is to be used, wherein the wrench head is mounted for movement with the toothed ratchet mount by threaded connectors, wherein the drive rod means is carried by and disposed parallel to said handle member and wherein a push button means is provided at the upper end of said drive rod means, for manually actuating said drive rod means.

7. Process for working on various sized nuts and bolts associated with underground pipes, through a hole at the ground surface and optionally employing any one of a plurality of pipe-engaging wrench heads for different sized nuts or bolts, wherein the depth of the pipe below ground is substantially greater than the size of the hole at the ground surface, the tool assembly comprising:
(a) providing a ratchet wrench tool assembly having an elongate handle member adapted to extend, at an upper end of the handle member, from a position substantially above a ground level hole to a location substantially proximate a below ground pipe at a lower end of the handle member;
(b) providing a ratchet mechanism of the ratchet teeth and pawl type mounted at a lower end of the handle member;
(c) providing a ratchet pawl drive rod adapted to extend from a position above a ground level hole to a ratchet pawl at the lower end of the handle member and for actuating said ratchet pawl from above ground;
(d) carrying the ratchet teeth on a toothed ratchet for turning movement therewith upon actuation by said drive rod means;
(e) connectably and disconnectably mounting a wrench head for movement with said toothed ratchet; whereby
(f) different sized wrench heads, each with multi-faceted nut or bolt gripping surfaces may be mounted for movement with said toothed ratchet to accommodate different sized nuts or bolts.

8. The process of claim 7, wherein said wrench head is provided with an open end for clearance over a pipe with which it is to be used.

9. The process of claim 7, including the step of mounting the wrench head for the movement with the toothed ratchet by threaded connectors.

10. The process of claim 7, including the step of carrying the drive rod by, and disposed substantially parallel to, the handle member.

11. The process of claim 7, including the step of manually actuating the drive rod means by a push button at the upper end of the drive rod.

12. The process of claim 7, wherein said wrench head is provided with an open end for clearance over a pipe with which it is to be used, including the step of mounting the wrench head for movement with the toothed ratchet by threaded connectors, including the step of carrying the drive rod by, and disposed substantially parallel to, the handle member and including the step of manually actuating the drive rod means by a push button at the upper end of the drive rod.
